(19) United States
(12) Patent Application Publication
(10) Pub. No.: US 2024/0121463 A1
(43) Pub. Date: Apr. 11, 2024

(54) TELEVISION REMOTE CONTROL SYSTEM WITH LOCATOR DEVICE

(71) Applicant: Hecoma Holdings LLC, Geneva, FL (US)

(72) Inventor: Amanda HERNANDEZ, Geneva, FL (US)

(21) Appl. No.: 18/377,102

(22) Filed: Oct. 5, 2023

Related U.S. Application Data
(60) Provisional application No. 63/413,473, filed on Oct. 5, 2022.

(51) Int. Cl. H04N 21/422

(52) U.S. Cl. CPC H04N 21/42222; H04N 21/4221; H04N 21/42221

(57) ABSTRACT

A television remote control system with locator device includes a remote control unit having a receiver coupled to a vibration motor, audio device, and a light tunnel. The system also includes a base unit having a transmitter configured to selectively transmit a radio frequency (RF) signal to the remote control unit to activate at least one of the vibration motor, the audio device, and the light tunnel. The base unit is configured to transmit the RF signal in response to a user depressing a button on the base unit so that the user can locate the remote control unit. The remote control unit has a child locking device configured to disable operation of the remote control unit, and also the light tunnel of the remote control unit passes through to opposing sides of the remote control unit so that a light is visible on either side.

### RELATED APPLICATIONS

This application is related to U.S. Provisional Patent Application Ser. No. 63/413,473 filed Oct. 5, 2022, the entire contents of which are incorporated herein by reference.

### FIELD

The present invention relates to the field of remote controls, and, more particularly, to a television remote control system with locator device.

### BACKGROUND

Existing remote controls for televisions have a transmitter for sending signals to the television, and some also have a receiver for receiving signals from another remote control. This enables the remote control to be programmed to emulate the other remote control. This is accomplished by associating particular buttons with signals transmitted by the other remote when corresponding buttons are pressed by the user. Thereafter, the user can use the remote control to control the other electronic devices.

In addition, users often misplace remote controls because of their relatively small size and shape. This makes it difficult to locate a remote control as they can fall under beds or down between furniture cushions for example. Existing methods to find remote controls include adhering an external device to the remote control that can be activated to signal the location of the device or using the television itself to send a signal to the remote control. However, these existing devices and methods are subject to failure and not being effective to signal to the user the exact location of the remote control.

Accordingly, there is a need in the art for a remote control that is easy to use and more effective in signaling the location of the remote control.

### SUMMARY

In view of the foregoing background, it is therefore an object of the present invention to provide a remote control system that is easy to operate and efficient to signal to the user the exact location of the remote control. This and other objects, features, and advantages in accordance with the present invention are provided by a television remote control system with locator device.

The system includes a remote control unit having a receiver coupled to a vibration motor, audio device, and a light tunnel. The system also Includes a base unit having a transmitter configured to selectively transmit a radio frequency (RF) signal (e.g., Bluetooth 2.4 Ghz frequency) to the remote control unit to activate at least one of the vibration motor, the audio device, and the light tunnel. The base unit is configured to transmit the RF signal in response to a user depressing a button on the base unit so that the user can locate the remote control unit. The base unit may have two buttons fox locating the remote control unit and a phone charging port (USB 3.0).

The remote control unit is configured to control a television and the remote control unit may have a child locking device configured to disable operation of the remote control unit. The light tunnel of the remote control unit passes through to opposing sides of the remote control unit so that a light is visible on the either side of the remote control unit making it easier to locate. The base unit may include a battery contact configured to charge a battery of the remote control unit when placed and docked with the base unit. The base connects to a wall outlet via a power cable with an outlet plug.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a front perspective view of a television remote control system with locator device in accordance with the present disclosure;

FIG. 2 is a right-side view of the system of FIG. 1;

FIG. 3 is a top view of a base of the system;

FIG. 4 is a front view of the system;

FIG. 5 is a front sectional view of the system;

FIG. 6 is a cross sectional view taken along line 6-6 of FIG. 5;

FIG. 7 is a detail partial view of a portion of the base of FIG. 6;

FIG. 8 is an exploded view of the remote control and the base of the system; and

FIG. 9 is a front view of button layout of the remote control of the system.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

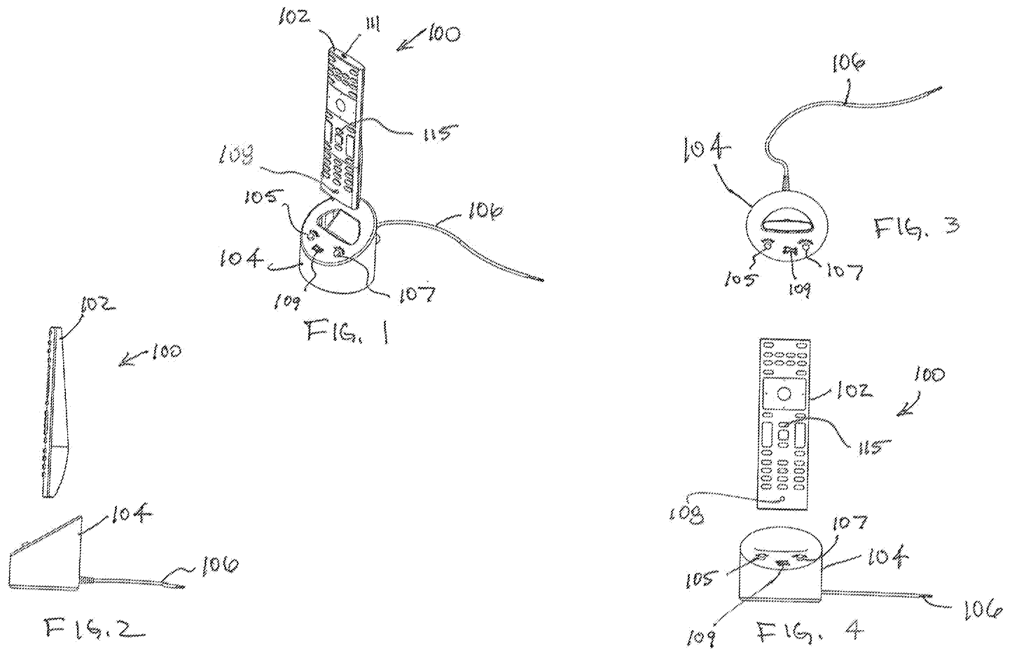

A television remote control system with locator device is disclosed in FIGS. 1-4 and generally designated 100. The system 100 includes a remote control unit 102 and a base unit 104. The base unit 104 includes a “sound” button 105 and a “vibrate” button 107 discussed below in more detail. The remote control unit also include a light tunnel 108 that is configured to house an LED 117. The LED 117 can be activated using the base unit 104.

The system 100 also includes a child lock function that can be activated to prevent accidental or unwanted activation of the remote control unit 102. The child lock function is activated by the user selecting the child lock button 115 on the remote control unit. In a particular aspect, the child lock button 115 is pressed three times to lock or unlock the function of the remote control unit 102. As those of ordinary skill in the art can appreciate, different sequencing of the pressing the child lock button 115 may be used to achieve the same function other than that described herein.

The purpose of the child lock function is to prevent babies, toddlers, and young children from accidentally changing the channel as they are playing with the remote control unit 102. For example, a child may find the remote control unit 102 and start pressing buttons randomly for fun while a parent is watching a television program. This causes the channel to change on the television and interrupts watching the program. Accordingly, the child lock function still allows the child to play with the remote control unit 102 and press buttons but without actually transmitting any signals to the television to change the channel.

The child lock button 115 is coupled to a printed circuit board (PCB) 130 that is programmed to detect a lock sequence of the child lock button 115 being pushed, Upon detecting the lock sequence, the PCB 130 is programmed to disable transmission of the signals to the television or other devices that are configured to be controlled by the remote control unit 102.

The base unit 104 includes a wireless transmitter 124 configured to transmit wireless signals (e.g., Bluetooth signals) to the receiver 116 of the remote control unit 102, and the base unit includes battery charger contacts 126 for charging a battery 112 of the remote control unit 102 when docked. The base unit 104 is connected to a power source via power cord 106. The base unit 104 may also have a USB charging port 111. The remote control unit 102 controls a television using infrared signals, for example, transmitted via lens 111 as those of ordinary skill in the art can appreciate.

Referring now to FIG. 5, internal components of the remote control 102 are shown. FIG. 6 is a cross-sectional view taken along the line 6-6 of FIG. 5. The remote control unit 102 includes a Bluetooth integrated circuit (IC) 118 and receiver 116 for receiving wireless signals from the base unit 104 that are used to activate at least one locator device of the remote control unit 102. The locator device may comprise an audio device 114, a vibration motor 120, the LED 117, and any combination thereof.

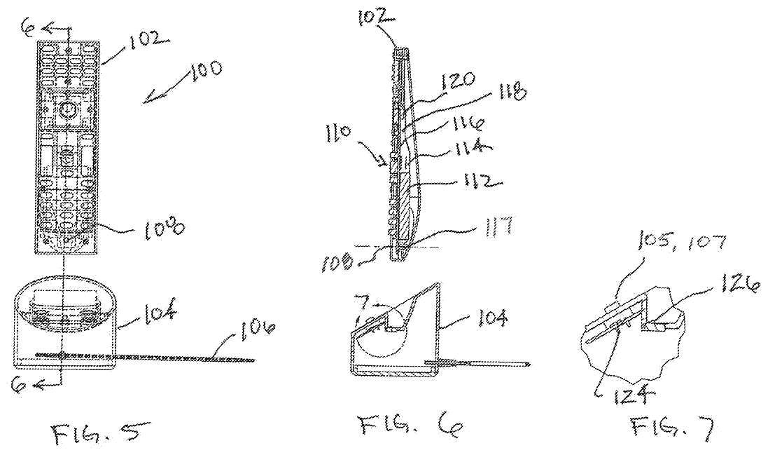

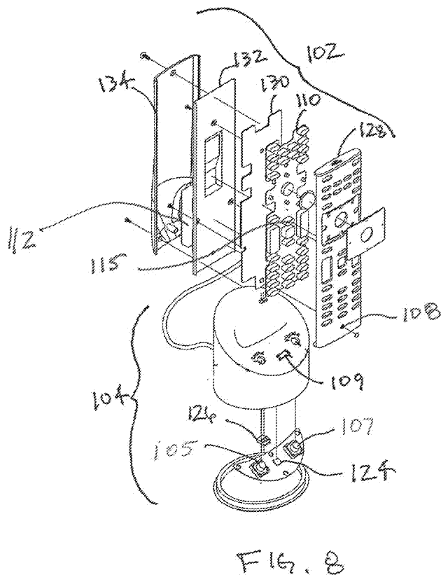

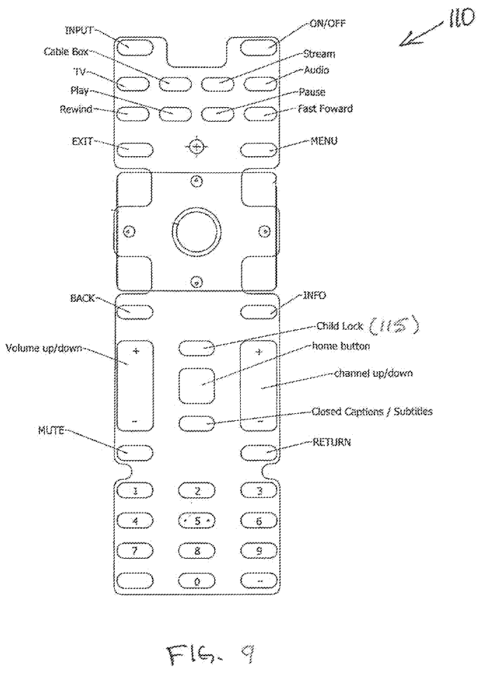

A cross-sectional detail view of the base unit 104 taken in the direction of line 7 of FIG. 6 is shown in FIG. 7. The base unit 104 includes the RF transmitter 124 that is used to send a locator signal to the remote control unit 102, As discussed above, the base unit 104 also includes locator buttons such as a sound button 105 and a vibrate button 107. The battery charger contacts 126 for charging the battery 112 of the remote control unit 102 when docked is also shown.

Referring now to FIG. 8, an exploded view of the remote control unit 102 and the base unit 104 is Shown. The remote control unit 102 includes a front cover 128, the remote control PCB 130, a center cover 132, and a back cover 134. The light tunnel 108 passes through the front cover 128 all the way through the back over 134 to project illumination from the LED 117.

In a particular aspect, the remote control unit 102 comprises a universal television remote with blank code that can be used with just about any television Accordingly, the remote control unit 102 may be configured to be programmed to be Cloud IR code compatible with any television. The remote control unit 102 may be configured to wirelessly control and operate four electronic devices such as a television, cable set top box, streaming device, and audio system. In addition, the remote control unit 102 may be configured to operate as a regular universal remote having a keypad 110.

The remote control unit 102 includes the rechargeable battery 112 positioned proximate a rear portion that is configured to be recharged on the base unit 104. The system 100 is configured to provide an audible or visual signal when the battery 112 of the remote control unit 102 is low and is required to be recharged. In addition, the remote control unit 102 may be water resistant.

A button layout of the remote control unit 102 is shown in FIG. 10. The various buttons have labels that correspond to controlling the respective function of the devices that are synchronized to the remote control unit 102. As those of ordinary skill in the art can appreciate, the buttons of the remote control unit 102 may be positioned differently without affecting the function of the system 100.

In operation of the system 100, when the user presses both the sound button 105 and the vibrate button 107 on the base unit 104, a wireless locator signal is transmitted via the RF transmitter 124 to the receiver 116 of the remote control unit 102 to cause the LED 117 to flash and illuminate the light tunnel 108. As a result, both sides of the remote control unit 102 will flash via the light tunnel 108, the vibration motor 120 will activate, and the audio device 114 makes a beeping noise, for example.

Alternatively, if the user only presses the vibrate button 107 for a silent mode then the LED 117 of the remote control unit 102 may flash and the vibration motor 120 is activated by the locator signal. If only the sound button 105 is pressed, then only the audio device 114 is activated to make the beeping noise in response to the locator signal.

In a particular aspect, the system 100 may be configured for a Bluetooth connection between the base unit 104 and the remote control unit 102. The system 100 may also be configured for a Bluetooth connection between the user's cell phone and the remote control unit 102. The remote control unit 102 may also have a standard IR signal transmitter 111 to control a television in addition to being configured to transmit Bluetooth signal to control the television.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A television remote control system with locator device comprising:
a remote control unit configured to wirelessly control an electronic device, wherein the remote control unit comprises
a printed circuit board (PCB),
a receiver coupled to the PCB,
a locator device coupled to the PCB and configured to be activated by the PCB in response to receiving a locator signal, wherein the locator device comprises a vibration motor, an audio device, and a light emitting diode (LED); and
a base unit having a first locator button and a transmitter, the transmitter configured to selectively transmit the locator signal to the remote control unit to activate at least one of the vibration motor, the audio device, the LED, or any combination thereof.

2. The television remote control system with locator device of claim 1, wherein the base unit is configured to transmit the locator signal in response to a user depressing the first locator button on the base unit so that the user can locate the remote control unit.

3. The television remote control system with locator device of claim 1, wherein the remote control unit is configured to control a television.

4. The television remote control system with locator device of claim 1, wherein the remote control unit comprises a child lock button coupled to the PCB, the PCB is programed to detect a lock sequence of the child lock button being pushed, and upon detecting the lock sequence the PCB is configured to disable the remote control unit from wirelessly controlling the electronic device.

5. The television remote control system with locator device of claim 4, wherein the remote control unit has a light tunnel defined therein that passes all the way through to project illumination from the LED when activated.

6. The television remote control system with locator device of claim 1, wherein the remote control unit comprises a rechargeable battery configured to power the PCB, the receiver, and the locator device.

7. The television remote control system with locator device of claim 6, wherein the base unit has a battery contact configured to charge the rechargeable battery of the remote control unit when placed in the base unit.

8. The television remote control system with locator device of claim 1, wherein the wireless signal of the transmitter comprises a Bluetooth signal.

9. A television remote control system with locator device comprising:
a remote control unit configured to wirelessly control an electronic device, wherein the remote control unit comprises a printed circuit board (PCB), a receiver coupled to the PCB, and a locator device coupled to the PCB and configured to be activated by the PCB in response to receiving a locator signal.

10. The television remote control system with locator device of claim 9, wherein the locator device comprises a vibration motor, an audio device, and a light emitting diode (LED).

11. The television remote control system and locator device of claim 10, further comprising a base unit having a first locator button and a transmitter, the transmitter configured to selectively transmit a wireless signal to the remote control unit to activate at least one of the vibration motor, the audio device, the LED, or any combination thereof.

12. The television remote control system with locator device of claim 11, wherein the base unit is configured to transmit the RF signal in response to a user depressing the first locator button on the base unit so that the user can locate the remote control unit.

13. The television remote control system with locator device of claim 12, wherein the remote control unit is configured to control a television.

14. The television remote control system with locator device of claim 13, wherein the remote control unit comprises a child lock button coupled to the PCB, the PCB is programed to detect a lock sequence of the child lock button being pushed, and upon detecting the lock sequence the PCB is configured to disable the remote control unit from wirelessly controlling the electronic device.

15. The television remote control system with locator device of claim 14, wherein the remote control unit has a light tunnel defined therein that passes all the way through to project illumination from the LED when activated.

16. The television remote control system with locator device of claim 15, wherein the remote control unit comprises a rechargeable battery configured to power the PCB, the receiver, and the locator device.

17. The television remote control system with locator device of claim 16, wherein the base unit has a battery contact configured to charge the rechargeable battery of the remote control unit when placed in the base unit.

18. The television remote control system with locator device of claim 17, wherein the wireless signal of the transmitter comprises a Bluetooth signal.

19. A method of using a television remote control system having a remote control unit comprising a locator device configured to be activated in response to receiving a locator signal from a base unit, the method comprising:
pressing at least one locator button on the base unit;
transmitting a wireless locator signal to a receiver of the remote control unit in response to the pressing of the at least one locator button; and
activating the locator device on the remote control unit in response to receiving the wireless locator signal.

20. The method of claim 19, further comprising flashing an LED to illuminate a light tunnel of the remote control unit.
